(19) United States
(12) Patent Application Publication
(10) Pub. No.: US 2006/0005147 A1
(43) Pub. Date: Jan. 5, 2006

(54) Methods and systems for controlling the display of maps aboard an aircraft

(76) Inventors: Jason L. Hammack, Seattle, WA (US); Peter D. Gunn, Seattle, WA (US); John C. Griffin III, Seattle, WA (US)

Correspondence Address: PERKINS COIE LLP;PATENT-SEA, P.O. BOX 1247, SEATTLE, WA, 98111-1247, US

(21) Appl. No.: 10/882,101

(22) Filed: Jun. 30, 2004

(51) Int. Cl. G06F 17/00; G06F 9/00

(52) U.S. Cl. 715/805; 715/855

(57) ABSTRACT

Systems and methods for displaying a map onboard an aircraft are disclosed. A method in accordance with one embodiment of the invention includes displaying a map of an area at least proximate to an aircraft at an aircraft flight deck during flight, with the map presenting a feature having a first position relative to a boundary of the map. The method can further include displaying at least one operator-selectable input element at least proximate to the display of the map and accessible to an operator of the aircraft. The method can still further include receiving via the at least one input element an operator-based request to change a position of the feature on the map relative to the boundary, and, in response to the request, updating the display of the map by shifting all points of the map so that the feature has a second position relative to the boundary, with the second position being different than the first position.

### TECHNICAL FIELD

The present invention is directed generally toward methods and systems for controlling the display of maps aboard an aircraft.

### BACKGROUND

Making maps computer-accessible has significantly increased the functionality and utility of maps in several contexts. For example, map databases available from sources such as Mapquest.com allow users to obtain maps of regions surrounding user-selected street addresses, and allow the users to adjust the displays of the maps by panning over the maps, and zooming in and out relative to a central point on the maps. Maps having this type of functionality have also been made available for aircraft flight planning. For example, products available from the Jeppesen Company of Denver, Colo. under the trade name Flitestar provide desktop computer-based planning maps that allow the user to pan over the map area and adjust the position at which the map is centered.

Map displays aboard commercial aircraft have also been computerized.

For example, FIG. 1 illustrates a flight deck 11 of an aircraft 10 having computer-based displays arranged in accordance with the prior art. The displays can include primary flight displays (PFDs) 14 and navigation displays 30, which are visually accessible to pilots seated in seats 16. The displays 14 and 30 are positioned beneath a glare shield 18, which shields the displays and other instruments from light entering through forward windows 13. A mode control panel 43 is positioned at the glare shield 18, and a pair of control and display units (CDUs) 15 are positioned on a control pedestal 17 between the seats 16 and below the glare shield 18. The CDUs 15 provide pilot access to a flight management computer 41. Instructions provided by the flight management computer 41 and the mode control panel 43 control automatic operation of the aircraft 10.

One characteristic of the flight deck 11 described above with reference to FIG. 1 is that the maps appearing at the navigation display 30 have limited functionality. For example, the pilot can step through waypoints along the aircraft's route, but is generally unable to have additional control over the manner in which the maps are presented at the navigation display 30. Furthermore, the pilot must typically provide instructions for the display of the maps at the CDU 15, which is remote from the navigation display 30. Accordingly, it can be awkward and/or non-intuitive for the pilot to control the manner in which the maps are displayed.

### SUMMARY

The present invention is directed generally toward methods and systems for displaying a map onboard an aircraft. A computer-implemented method in accordance with one aspect of the invention includes displaying a map of an area at least proximate to an aircraft at an aircraft flight deck during flight, with the map presenting a feature having a first position relative to a boundary of the map. The method can further include displaying at least one operator-selectable input element at least proximate to the display of the map and accessible to an operator of the aircraft. The method can still further include receiving via the at least one input element an operator-based request to change a position of the feature on the map relative to the boundary, and in response to the request, updating the display of the map by shifting all points of the map so that the feature has a second position relative to the boundary, with the second position being different than the first position.

In further particular aspects of the invention, the map can be displayed at a display screen and the method can include presenting first, second, third, fourth, and fifth operator-selectable icons superimposed on the display of the map at the display screen. The first icon can be used by the operator to center the map on a current location of the aircraft, the second icon can be used to center the map relative to an entire route of the aircraft, the third icon can be used to center the map on an active waypoint of a route of the aircraft, the fourth icon can be used to sequentially center the map on a series of such waypoints, and the fifth icon can be used to center the map on a target location. For example, when the fifth icon is selected, the method can include prompting an operator to provide a target location identified by a waypoint identifier or latitude and longitude coordinates, receiving an instruction from an operator identifying a waypoint or latitude and longitude coordinates corresponding to the target location, and in response to receiving the instruction from the operator, centering the display on the target location.

A computer system in accordance with another aspect of the invention can include a display portion configured to display a map of an area at least proximate to an aircraft onboard the aircraft, with the map presenting a feature having a first position relative to a boundary of the map. The display portion can further be configured to update the display of the map in response to an operator request by shifting all points of the map so that the feature has a second position relative to the boundary, with the second position being different than the first position. A receiver portion can be configured to receive the operator request from the operator via at least one operator-selectable input element positioned at least proximate to the display of the map.

### BRIEF DESCRIPTION OF THE DRAWINGS

FIG. 1 is a partially schematic, isometric illustration of the interior of a flight deck configured in accordance with the prior art.

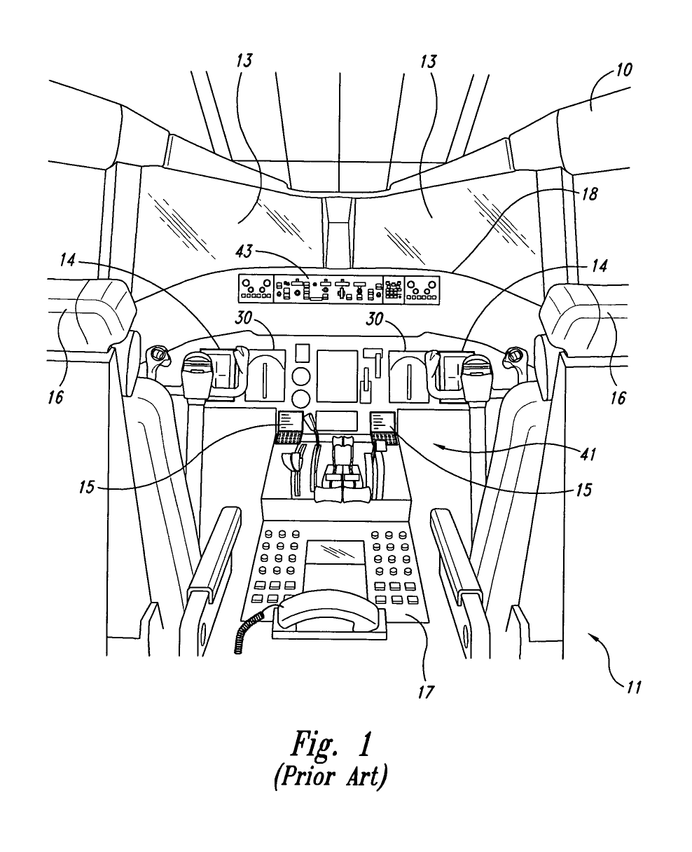

FIG. 2 is a schematic illustration of an aircraft system for controlling the display of the maps in accordance with an embodiment of the invention.

FIG. 3 is a flow diagram illustrating a method for controlling the display of maps at an aircraft flight deck in accordance with an embodiment of the invention.

FIG. 4 illustrates a display presenting a map and operator-selectable input elements for controlling the display of the map in accordance with an embodiment of the invention.

FIG. 5 illustrates the display presenting a map centered on an aircraft indicator, as requested by an operator in accordance with another embodiment of the invention.

FIG. 6 illustrates the display presenting the entire route of the aircraft, as requested by an operator in accordance with an embodiment of the invention.

FIG. 7 illustrates the display presenting a map centered on an active waypoint, as requested by an operator in accordance with yet another embodiment of the invention.

FIG. 8 illustrates the display presenting a waypoint prompt at which the operator can enter an arbitrary waypoint or arbitrary coordinates in accordance with still another embodiment of the invention.

### DETAILED DESCRIPTION

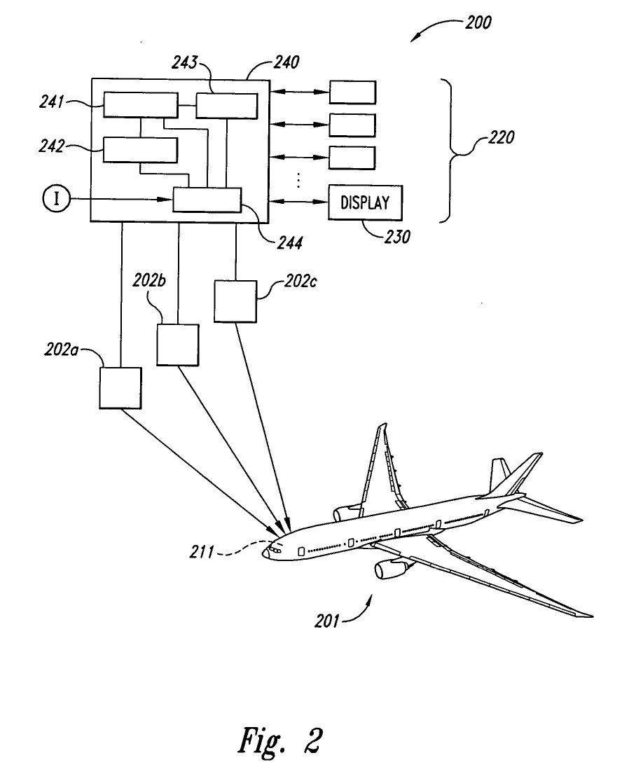

The following disclosure describes systems and methods for displaying aircraft navigation maps at an aircraft flight deck. Certain specific details are set forth in the following description and in FIGS. 2-8 to provide a thorough understanding of various embodiments of the invention. Well-known structures, systems and methods often associated with electronically displaying maps have not been shown or described in detail below to avoid unnecessarily obscuring the description of the various embodiments of the invention. In addition, those of ordinary skill in the relevant art will understand that additional embodiments of the present invention may be practiced without several of the details described below.

Many embodiments of the invention described below may take the form of computer-executable instructions, such as routines executed by a programmable computer. Those skilled in the relevant art will appreciate that the invention can be practiced on other computer system configurations as well. The invention can be embodied in a special-purpose computer or data processor that is specifically programmed, configured or constructed to perform one or more of the computer-executable instructions described below. Accordingly, the term “computer” as generally used herein includes any processor and can include Internet appliances, hand-held devices (including palm-top computers, wearable computers, cellular or mobile phones, multiprocessor systems, processor-based or programmable consumer electronics, mini-computers and the like).

The invention can also be practiced in distributed computing environments, in which tasks or modules are performed by remote processing devices that are linked with a communications network. In a distributed computing environment, program modules or subroutines may be located in both local and remote memory storage devices. Aspects of the invention described below may be stored or distributed on computer-readable media, including magnetic or optically readable computer disks (e.g., removable disks) as well as distributed electronically over networks. Data structures and transmissions of data particular to aspects of the invention are also encompassed within the scope of the invention. Information handled in accordance with aspects of the invention can be presented at any of a variety of display media, for example, CRT screens, LCD screens, or other suitable devices.

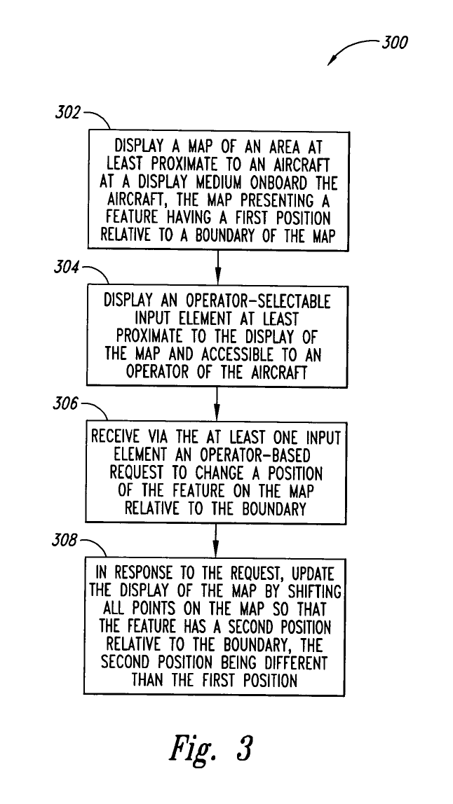

FIG. 2 is a schematic illustration of an aircraft 201 having a system 200 configured to receive instructions and display information in accordance with an embodiment of the invention. Portions of the system 200 can be housed at a flight deck 211 of the aircraft 201 for access by an operator (e.g., a pilot). The aircraft 201 can have a fixed wing configuration (as shown in FIG. 2) or other configurations (e.g., rotary wing configurations). In one aspect of this embodiment, the system 200 can include input/output devices 220 via which the operator and/or aircraft subsystems can provide information to a computer (e.g., a flight guidance computer 240). The flight guidance computer 240 can include one or more processors, one or more memories, a flight management computer 241, linked to a control and display unit (CDU) 242, and a mode control panel (MCP). These portions of the flight guidance computer 240 can all be linked to one or more receivers 244. Accordingly, the flight guidance computer 240 can receive instructions I from the operator and present and update information at a display 230, based on the instructions. In other embodiments, the flight guidance computer 240 can include other devices and/or arrangements, e.g., autoflight computers, autopilots, and/or autothrottles. In any of these embodiments, the flight guidance computer 240 can be linked to one or more aircraft control systems 202, shown in FIG. 2 as a lateral motion or a roll control system 202a, a vertical motion controller 202b, and an airspeed or engine control system 202c to control the aircraft direction, altitude and speed. At the same time, the flight guidance computer 240 updates the maps presented at the display 230 as the aircraft 201 changes direction, altitude and speed along its route. Aspects of the manners in which the maps are displayed and updated in accordance with operator instructions are described in greater detail below with reference to FIGS. 3-8.

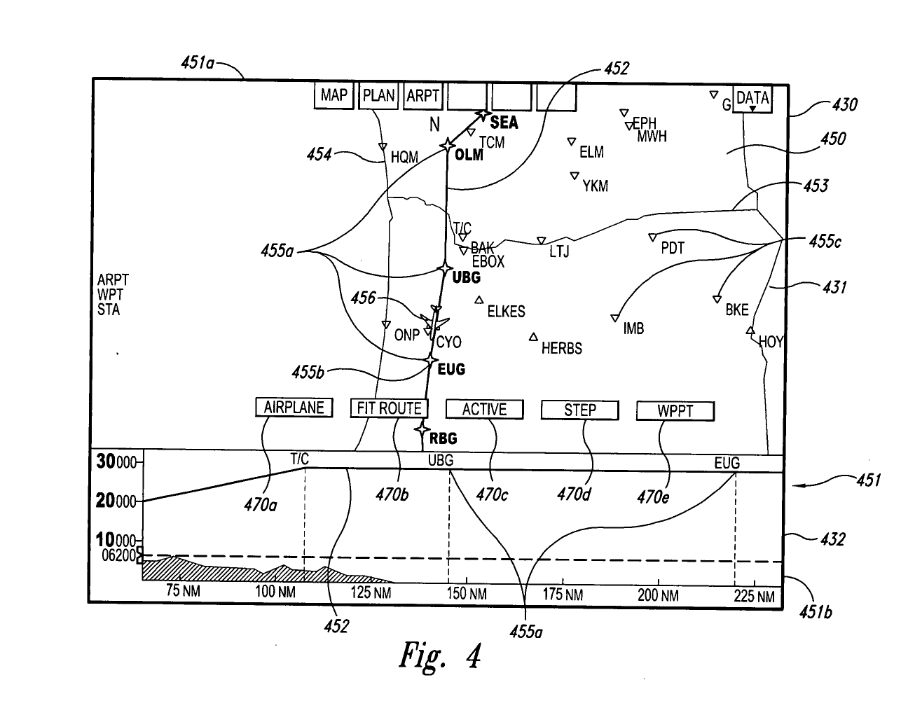

FIG. 3 is a flow diagram illustrating a process 300 for displaying a map aboard an aircraft in accordance with an embodiment to the invention. The process 300 can include displaying a map of an area at least proximate to the aircraft at a display medium onboard the aircraft, with the map presenting a feature having a first position relative to a boundary of the map (process portion 302). In process portion 304, the system displays an operator-selectable input element at least proximate to the display of the map, with the input element accessible to an operator of the aircraft. In a particular aspect of this embodiment, the input element can include an icon superimposed on the display of the map. In process portion 306, the system receives (via the at least one input element) an operator-based request to change a position of the feature on the map relative to the boundary. The feature can include an active waypoint, the entire route of the aircraft, the present location of the aircraft, an arbitrary waypoint or set of coordinates, a geographical feature, a political boundary and/or other features. In process portion 308, the system can, in response to the request, update the display of the map by shifting all points of the map so that the feature has a second position relative to the boundary, with the second position being different than the first position. For example, process portion 308 can include centering the display of the map on the feature. FIGS. 4-8 provide examples of manners in which the foregoing method can be implemented onboard the aircraft.

FIG. 4 illustrates a display or display page 430 presenting a map 450 in accordance with an embodiment of the invention. The map 450 can include a plan portion 431, which is a simulated view of the route being flown by the aircraft, from a point above the aircraft. The map 450 can also include a vertical situation display (VSD) or elevation portion 432, illustrating an elevation view of the aircraft's route 452. The route 452 can be presented at both the plan portion 431 and the elevation portion 432 of the map 450. The map 450 can include a series of route waypoints 455a, along with an aircraft indicator 456 identifying the current location of the aircraft. An active waypoint 455b corresponds to the waypoint toward which the aircraft is currently being directed. Non-route waypoints 455c can also be displayed on the map 450, for example, in a different manner than the route waypoints 455a to highlight the fact that the non-route waypoints 455c are not part of the current aircraft flight plan.

The map 450 can include geographic boundaries 454 (e.g., shorelines) and/or political boundaries 453 (e.g., provincial, national, and international boundaries). The map 450 can be bounded by a map boundary 451 which, in an embodiment shown in FIG. 4, includes a first boundary 451a around the plan portion 431, adjacent to a second boundary 451b around the elevation portion 432. Each boundary 451a, 451b defines a generally rectangular shape. In other embodiments, the map boundary 451 can define other shapes.

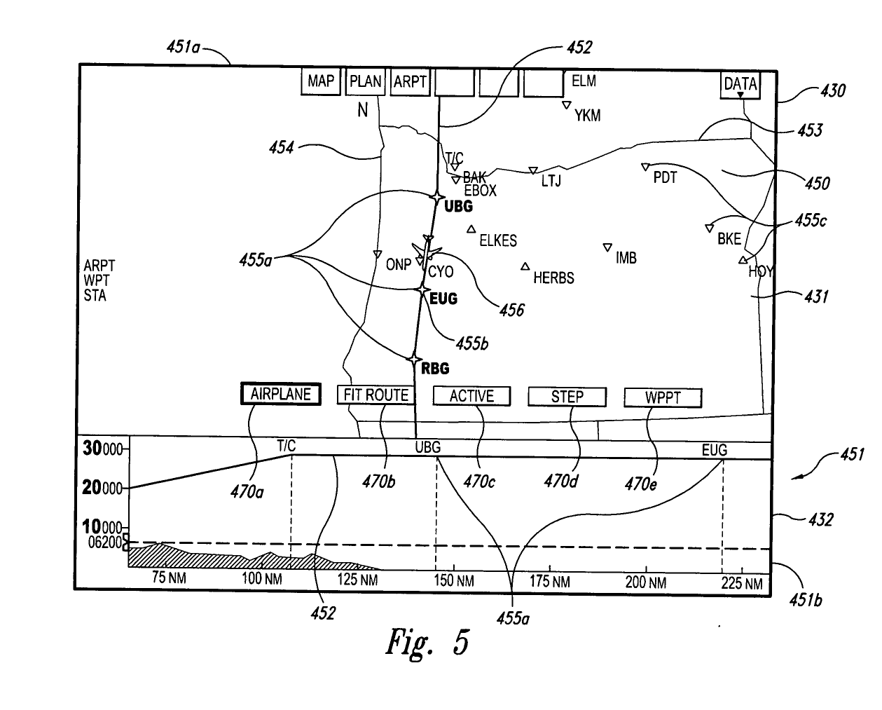

As the aircraft progresses along the route 452, the system can automatically update the display of the map 450. The operator can also manipulate the presentation of the map 450, simultaneously with and independently of the automatic updates. Accordingly, the display 430 can also include a plurality of input elements 470 (shown as first, second, third, fourth, and fifth input elements 470a-470e) that allow the operator to actively adjust the display of the map 450. By activating the input elements 470, the operator can adjust the location of one or more features of the map 450 relative to the map boundary 451, independent of the motion of the aircraft and independent of automatic updates that the system provides as the aircraft flies along its route. The input elements 470 can include icons or other electronically-based images that the operator can use to transmit input signals. For example, the user can select one of the input elements 470 by moving a cursor with a cursor control device (e.g., mouse) or keyboard key (e.g., an arrow key or tab key). The user can transmit the input signal by activating a key at the cursor control device or the keyboard. Once the display of the map 450 has been adjusted using these techniques, the operator can provide further inputs, e.g., to zoom in or zoom out the display. Examples of the manners in which the map display is updated are provided below with reference to FIGS. 5-8.

As shown in FIG. 5, the operator has selected the first input element 470a (labeled “AIRPLANE” in FIG. 5) to center the display of the map 450 on the current location of the aircraft. Accordingly, the display of the map 450 has shifted so that the aircraft indicator 456 is at least approximately centered within the first map boundary 451a. This particular display format can be helpful to the operator by providing a balanced presentation of the area on all sides of the aircraft's current location.

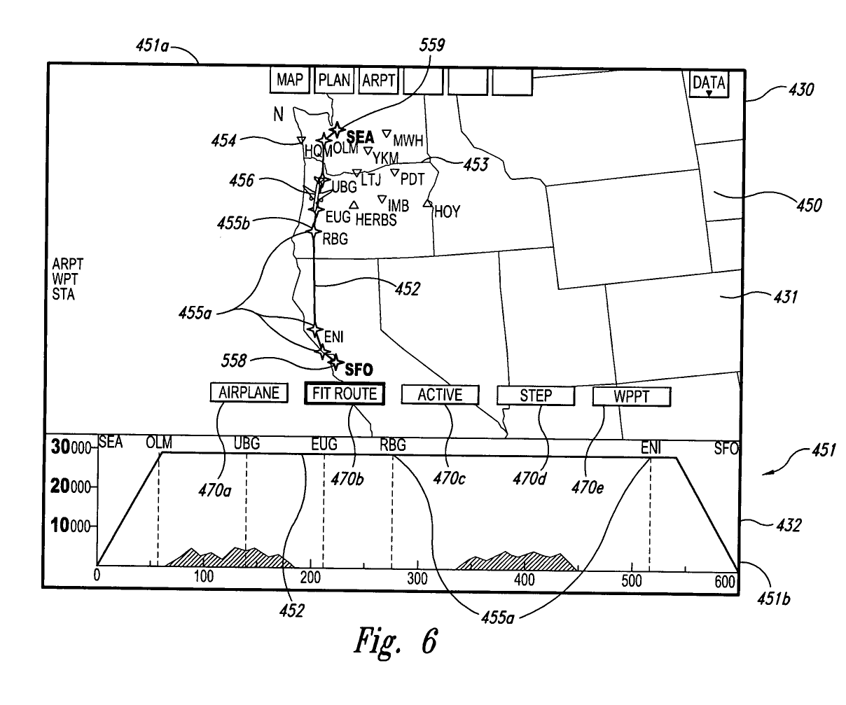

FIG. 6 illustrates the display 430 after the operator has activated the second input element 470b (labeled “FIT ROUTE” in FIG. 6). In response to receiving an input via the second input element 470b, the system has updated the map 450 to display the entire route of the aircraft, including a route start point 559 and a route end point 558. The size of the map presented at the display 430, and the distances between points on the map and points on the first map boundary 451c have accordingly shifted to allow the entire route 452 to be fit within the confines of the first map boundary 451a. The size of the map shown at the elevation portion 432 has also shifted to allow the entire route 452 to fit within the second map boundary 451b. An advantage of presenting the entire route in this manner is that it allows the operator to see at a glance all the waypoints along the aircraft's route 452, and also allows the operator to identify alternate airports (only some of which are shown in FIG. 6) should a diversion become necessary.

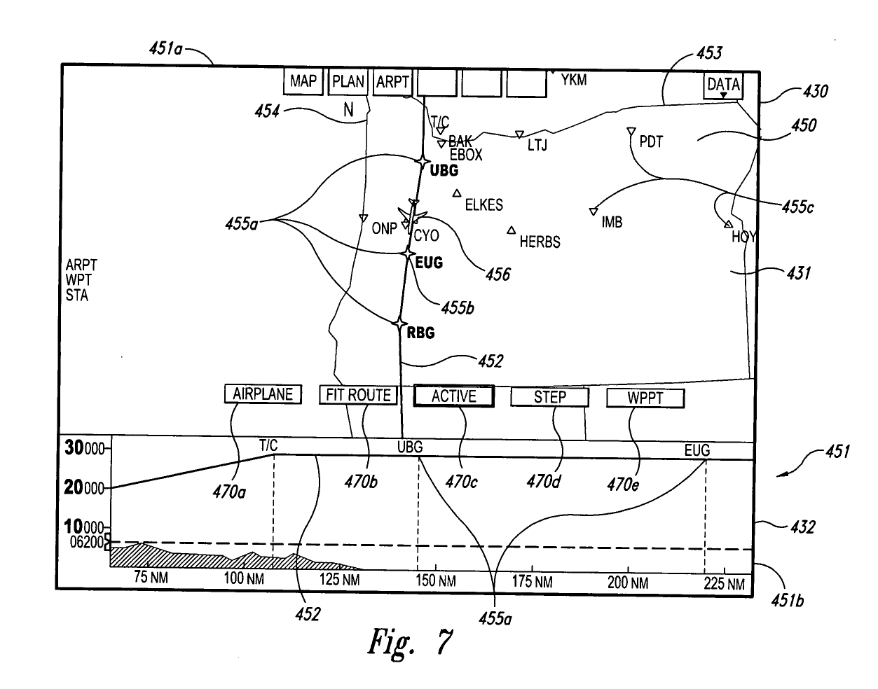

FIG. 7 illustrates the map 450 after the operator has activated the third input element 470c (labeled “ACTIVE” in FIG. 7). In response to receiving an input via the third input element 470c, the system has centered the map 450 on the active waypoint along the aircraft's route 452. Accordingly, the system has shifted the display of the map 450 so that the next waypoint ahead of the current aircraft position is at least approximately centered within the first map boundary 451a. In a particular aspect of the embodiment, the system can obtain the coordinates of the currently active waypoint 455b directly or indirectly from a flight plan list stored on a flight management computer or other component of the flight guidance computer 240 (FIG. 2). The operator can also serially step from one waypoint to the next (including the active waypoint) by providing an input at the fourth input element 470d (labeled “STEP” in FIG. 7).

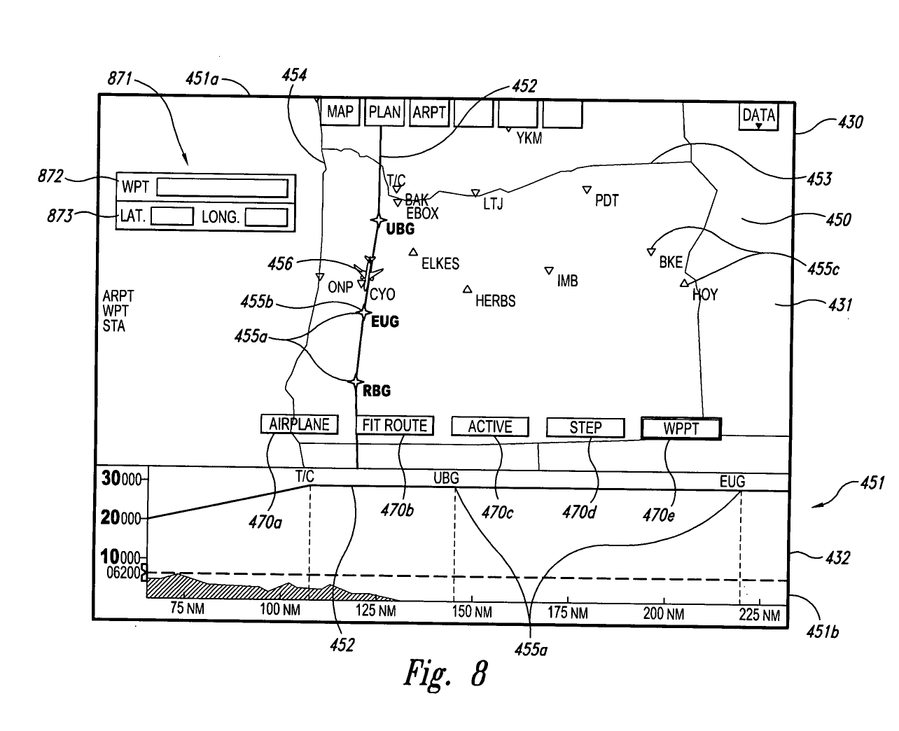

FIG. 8 illustrates the display 430 after the operator has entered an instruction via the fifth input element 470e (labeled “WAYPOINT” in FIG. 8). Upon receiving an input request via the fifth input element 470e, the system can present a waypoint prompt 871 (e.g., a dialog box), superimposed on the map 450. The waypoint prompt 871 can include a waypoint input portion 872 and an arbitrary point input portion 873. The waypoint input portion 872 can include a window at which the operator can enter a waypoint identifier (e.g., any of the three-, four- or five-letter waypoint identifiers shown on the map 450, or located outside the display range of the map 450). The operator can also enter an arbitrary latitude and longitude coordinate pair via the arbitrary point input portion 873. In either embodiment, the system can automatically center the display of the map 450 on the point identified by the operator thereby presenting a different geographical area than was initially presented. An advantage of this arrangement is that the operator can easily focus on a particular waypoint or, for example, where waypoints are not densely distributed, on an arbitrary point that is not necessarily part of the pre-planned route for the aircraft. This can be particularly helpful to the operator, for example, when the operator wishes to consider diverting the aircraft to overfly an unplanned waypoint.

One feature of several of the embodiments described above with reference to FIGS. 2-8 is that the input elements 470 can be presented at a consolidated location at least proximate to the map 450, for example, in a row that is superimposed over the map 450. An advantage of this arrangement is that the operator need not enter inputs related to the way in which the map is displayed at a location that is remote from the map itself. Accordingly, this arrangement can be easier to use and more intuitive for the operator.

Another feature of several of the embodiments described above with reference to FIGS. 2-8 is that the input elements 470 can significantly increase the options available to the operator for manipulating the display of the map 450, compared with conventional flight deck displays. For example, the operator can center the map on the current aircraft location, the current active waypoint, the entire planned route of the aircraft, and/or an arbitrary waypoint or coordinate location. An advantage of this feature is that it can significantly increase the utility of the map and can provide the operator with additional planning information not currently available. This feature can also allow the aircraft owner or operator to specify which options (e.g., some or all) are to be installed and/or made available on particular aircraft.

Another feature of at least some of the embodiments described above with reference to FIGS. 2-8 is that the elevation portion 432 of the map 450 can be automatically updated to reflect shifts in the display of the plan portion 431. An advantage of this arrangement is that the elevation portion 432 and the plan portion 431 can be displayed in a mutually consistent manner, even as the point on which the plan portion 431 is centered shifts in response to the operator's inputs.

From the foregoing, it will be appreciated that specific embodiments of the invention have been described herein for purposes of illustration, but that various modifications may be made without deviating from the spirit and scope of the invention. For example, aspects of the invention described in the context of particular embodiments can be combined or eliminated in other embodiments. Accordingly, the invention is not limited except as by the appended claims.

I/we claim:

1. A computer-implemented method for displaying a map onboard an aircraft, comprising:
displaying a map of an area at least proximate to an aircraft at an aircraft flight deck during flight, the map presenting a feature having a first position relative to a boundary of the map;
displaying at least one operator-selectable input element at least proximate to the display of the map and accessible to an operator of the aircraft;
receiving via the at least one input element an operator-based request to change a position of the feature on the map relative to the boundary; and
in response to the request, updating the display of the map by shifting all points of the map so that the feature has a second position relative to the boundary, the second position being different than the first position.

2. The method of claim 1 wherein displaying a map includes displaying a map at a display screen, and wherein displaying at least one operator-selectable input element includes presenting first, second, third, fourth, and fifth operator-selectable icons superimposed on the display of the map at the display screen, and wherein:
a direction received when the first icon is selected corresponds to a request to center the map on a current location of the aircraft;
a direction received when the second icon is selected corresponds to a request to center the map relative to an entire route of the aircraft;
a direction received when the third icon is selected corresponds to a request to center the map on an active waypoint of a route of the aircraft;
a direction received when the fourth icon is selected corresponds to a request to sequentially center the map on a series of waypoints of a route of the aircraft; and
a direction received when the fifth icon is selected corresponds to a request to:
prompt an operator onboard the aircraft to provide a target location, the target location being identified by a waypoint identifier or latitude and longitude coordinates;
receive an instruction from an operator identifying a waypoint or latitude and longitude coordinates corresponding to the target location; and
in response to the instruction from the operator, centering the display on the target location.

3. The method of claim 1 wherein the map includes a plan view map, and wherein the method further comprises:
presenting a elevation view map of altitude as a function of ground distance, along with an identifier indicating a current position of the aircraft, the elevation view map being presented at least proximate to the plan view map; and
in response to the request, updating the display of the elevation view map.

4. The method of claim 1 wherein displaying a map presenting a feature includes displaying a map presenting a ground feature.

5. The method of claim 1 wherein displaying at least one operator-selectable input element includes presenting at least one operator-selectable icon at least proximate to the display of the map.

6. The method of claim 1 wherein displaying at least one operator-selectable input element includes superimposing at least one operator-selectable icon on the display of the map.

7. The method of claim 1 wherein displaying at least one operator-selectable input element includes presenting an operator-selectable icon at least proximate to the display of the map, and wherein a direction received when the icon is selected corresponds to a request to center the map on a current location of the aircraft.

8. The method of claim 1 wherein displaying at least one operator-selectable input element includes presenting an operator-selectable icon at least proximate to the display of the map, and wherein a direction received when the icon is selected corresponds to a request to center the map relative to a route of the aircraft.

9. The method of claim 1 wherein displaying at least one operator-selectable input element includes presenting an operator-selectable icon at least proximate to the display of the map and wherein a direction received when the icon is selected corresponds to a request to center the map on an active waypoint of a route of the aircraft.

10. The method of claim 1 wherein displaying at least one operator-selectable input element includes presenting an operator-selectable icon at least proximate to the display of the map, and wherein a direction received when the icon is selected corresponds to a request to sequentially center the map on a series of waypoints of a route of the aircraft.

11. The method of claim 1 wherein displaying at least one operator-selectable input element includes presenting an operator-selectable icon at least proximate to the display of the map, and wherein a direction received when the icon is selected corresponds to a request to:
prompt an operator onboard the aircraft to provide a target location, the target location being identified by a waypoint identifier or latitude and longitude coordinates;
receive an instruction from an operator identifying a waypoint or latitude and longitude coordinates corresponding to the target location; and
in response to the instruction from the operator, center the display on the target location.

12. A computer-implemented method for displaying a map onboard an aircraft, comprising:
displaying a map of an area at least proximate to an aircraft onboard the aircraft;
displaying an identifier indicating a current position of the aircraft, the identifier having a first location relative to a boundary of the map;
receiving an input requesting a change in the location of the identifier relative to the boundary of the map, independent of the movement of the aircraft; and
in response to the input, updating the display of at least one of the map and the identifier so that the identifier has a second location relative to the boundary of the map, the second location being different than the first location.

13. The method of claim 12 wherein receiving an input includes receiving an input requesting that the identifier be centered relative to an area of the map.

14. The method of claim 12 wherein receiving an input includes receiving an input requesting that the entirety of a planned route for the aircraft be displayed along with the identifier.

15. The method of claim 12 wherein the map includes a plan view map, and wherein the method further comprises presenting an elevation view map of altitude as a function of ground distance, along with an identifier indicating a current position of the aircraft, the elevation view map being presented at least proximate to the plan view map.

16. A computer-implemented method for displaying a map aboard an aircraft, comprising:
displaying a computer-based image of a map onboard an aircraft;
receiving a request to update the map display based on a currently active waypoint target; and
centering the map display on the currently active waypoint target.

17. The method of claim 16, further comprising receiving a location for the currently active waypoint target.

18. The method of claim 16, further comprising receiving a location for the currently active waypoint target by reference to a flight plan list of waypoint targets.

19. The method of claim 16, further comprising displaying along with the map an identifier indicating a current position of the aircraft.

20. The method of claim 16, further comprising presenting an operator-selectable icon at least proximate to the display of the map, and wherein receiving a request to update the map display includes receiving a request when an operator selects the icon.

21. A computer-implemented method for displaying a map aboard an aircraft, comprising:
displaying a map onboard an aircraft, the map representing a first geographical area;
receiving a request to update the map display;
in response to the request, prompting an operator onboard the aircraft to provide a target location, the target location being identified by a waypoint identifier or latitude and longitude coordinates;
receiving an instruction from an operator identifying a waypoint or latitude and longitude coordinates corresponding to the target location; and
in response to the instruction from the operator, updating the display to present a second geographical area different than the first geographical area.

22. The method of claim 21 wherein updating the display includes centering a display of the map on the target location.

23. The method of claim 21, further comprising displaying along with the map an identifier indicating a current position of the aircraft.

24. The method of claim 21, further comprising presenting an operator-selectable icon at least proximate to the display of the map, and wherein receiving a request to update the map display includes receiving a request when an operator selects the icon.

25. A computer-readable medium having contents capable of performing a method, comprising:
displaying a map of an area at least proximate to an aircraft onboard the aircraft, the map presenting a feature having a first position relative to a boundary of the map;
displaying at least one operator-selectable input element at least proximate to the display of the map and accessible to an operator of the aircraft;
receiving via the at least one input element an operator-based request to change a position of the feature on the map relative to the boundary; and
in response to the request, updating the display of the map by shifting all points of the map so that the feature has a second position relative to the boundary, the second position being different than the first position.

26. The computer-readable medium of claim 25 wherein displaying a map includes displaying a map at a display screen, and wherein displaying at least one operator-selectable input element includes presenting first, second, third, fourth, and fifth operator-selectable icons superimposed on the display of the map at the display screen, and wherein:
a direction received when the first icon is selected corresponds to a request to center the map on a current location of the aircraft;
a direction received when the second icon is selected corresponds to a request to center the map on a midpoint of a route of the aircraft;
a direction received when the third icon is selected corresponds to a request to center the map on an active waypoint of a route of the aircraft;
a direction received when the fourth icon is selected corresponds to a request to sequentially center the map on a series of waypoints of a route of the aircraft; and
a direction received when the fifth icon is selected corresponds to a request to:
prompt an operator onboard the aircraft to provide a target location, the target location being identified by a waypoint identifier or latitude and longitude coordinates;
receive an instruction from an operator identifying a waypoint or latitude and longitude coordinates corresponding to the target location; and
in response to the instruction from the operator, centering the display on the target location.

27. The computer-readable medium of claim 25 wherein the map includes a plan view map, and wherein the method further comprises:
presenting an elevation view map of altitude as a function of ground distance, along with an identifier indicating a current position of the aircraft, the elevation view map being presented at least proximate to the plan view map; and
in response to the request, updating the display of the elevation view map.

28. The computer-readable medium of claim 25 wherein displaying a map presenting a feature includes displaying a map presenting a ground feature.

29. The computer-readable medium of claim 25 wherein displaying at least one operator-selectable input element includes superimposing at least one operator-selectable icon on the display of the map.

30. The computer-readable medium of claim 25 wherein displaying at least one operator-selectable input element includes presenting an operator-selectable icon at least proximate to the display of the map, and wherein a direction received when the icon is selected corresponds to a request to center the map on a current location of the aircraft.

31. The computer-readable medium of claim 25 wherein displaying at least one operator-selectable input element includes presenting an operator-selectable icon at least proximate to the display of the map, and wherein a direction received when the icon is selected corresponds to a request to center the map on a midpoint of a route of the aircraft.

32. The computer-readable medium of claim 25 wherein displaying at least one operator-selectable input element includes presenting an operator-selectable icon at least proximate to the display of the map and wherein a direction received when the third icon is selected corresponds to a request to center the map on an active waypoint of a route of the aircraft.

33. The computer-readable medium of claim 25 wherein displaying at least one operator-selectable input element includes presenting an operator-selectable icons at least proximate to the display of the map, and wherein a direction received when the icon is selected corresponds to a request to:
prompt an operator onboard the aircraft to provide a target location, the target location being identified by a waypoint identifier or latitude and longitude coordinates;
receive an instruction from an operator identifying a waypoint or latitude and longitude coordinates corresponding to the target location; and
in response to the instruction from the operator, centering the display on the target location.

34. A computer system configured to display aircraft navigation information, comprising:
a display portion configured to display a map of an area at least proximate to an aircraft onboard the aircraft, the map presenting a feature having a first position relative to a boundary of the map, the display portion further being configured to update the display of the map in response to an operator request by shifting all points of the map so that the feature has a second position relative to the boundary, the second position being different than the first position; and
a receiver portion configured to receive the operator request from the operator via at least one operator-selectable input element at least proximate to the display of the map.

35. The system of claim 34 wherein the display portion is configured to display first, second, third, fourth, and fifth operator-selectable icons superimposed on the display of the map at a display screen, and wherein:
the receiver portion is configured to receive a request to center the map on a current location of the aircraft when the first icon is selected;
the receiver portion is configured to receive a request to center the map relative to a route of the aircraft when the second icon is selected;
the receiver portion is configured to receive a request to center the map on an active waypoint of a route of the aircraft when the third icon is selected;
the receiver portion is configured to receive a request to sequentially center the map on a series of waypoints of a route of the aircraft when the fourth icon is selected; and
the receiver portion is configured to receive a request to:
prompt an operator onboard the aircraft to provide a target location, the target location being identified by a waypoint identifier or latitude and longitude coordinates;
receive an instruction from an operator identifying a waypoint or latitude and longitude coordinates corresponding to the target location; and
in response to the instruction from the operator, centering the display on the target location, when the fifth icon is selected.

36. The system of claim 34 wherein the map includes a plan view map, and wherein the display portion is configured to present an elevation view map of altitude as a function of ground distance, along with an identifier indicating a current position of the aircraft, the elevation view map being presented at least proximate to the plan view map and, in response to the request, update the display of the elevation view map.

37. The system of claim 34 wherein the display portion is configured to superimpose at least one operator-selectable icon on the display of the map.
